(19) United States
(12) Patent Application Publication
(10) Pub. No.: US 2004/0172648 A1
(43) Pub. Date: Sep. 2, 2004

(54) Channel navigation based on channel attribute information

(76) Inventors: Shan Xu, Beijing (CN); Peter T. Barrett, San Francisco, CA (US); Zhi-Guang Zhou, Beijing (CN); Zhi Zheng, Beijing (CN); Mingda Pan, Beijing (CN); Qin Hong, Beijing (CN); Youshun Liu, Beijing (CN); Yu Yang, Beijing (CN); Yurong Wang, Beijing (CN)

Correspondence Address: LEE & HAYES PLLC, 421 W RIVERSIDE AVENUE SUITE 500, SPOKANE, WA, 99201

(21) Appl. No.: 10/377,183

(22) Filed: Feb. 28, 2003

(51) Int. Cl. H04N 7/173; H04N 5/445; G06F 3/00; H04N 5/44; H04N 5/50; G06F 13/00

(52) U.S. Cl. 725/38; 348/734; 348/731; 725/52

(57) ABSTRACT

A mechanism is provided which allows a user to navigate through channels with programs that share related attribute information, such as a common category. The channels can include at least one broadcast channel that presents programs at scheduled times, and at least one on-demand channel that presents programs for viewing at user-specified times.

### TECHNICAL FIELD

This invention relates to a method, system, and apparatus for navigating through channels, and more particularly, to a method, system, and apparatus for navigating through channels, where each channel contains multiple programs.

### BACKGROUND

Current television program delivery technology provides a user with a great number of television channels to select from. Further, each of these channels includes multiple programs of varying content. On one hand, the availability of a large number of programs benefits the user, as this body of resources is more likely to include a particular program that interests the user. On the other hand, the availability of such a large number of programs may make program viewing more complicated and frustrating for the user. For instance, the user must now navigate through a large number of channels to select a desired program. This navigation is commonly performed using a conventional channel input mechanism, such as a remote controller. For instance, a user may select a desired channel by directly entering the channel number of the desired channel using a numeric keypad provided by the remote controller, or by sequencing through a series of channels to arrive at the desired channel using a “channel up-down” key provided by the remote controller. This activity can become tedious when there are a large number of channels containing programs. For instance, in the case of sequencing through the channels using the channel up-down key, the user must often sequence through a great number of channels to arrive at the desired channel.

This problem is compounded due to the viewing habits of many users. For instance, many users do not watch a single program from start to finish in uninterrupted fashion, but rather frequently switch among a group of programs being played on different channels at the same time. This viewing habit becomes cumbersome if the user must navigate through a vast array of programs on different channels using the traditional techniques described above.

Accordingly, there is an exemplary need in the art for a more efficient way of navigating through channels containing programs.

### SUMMARY

A solution to the above-identified need is described herein. In one implementation, a method is described for advancing through channels containing programs. The method includes: (a) receiving an indication that a user has activated a channel advancement mechanism while playing an initial program in an initial channel; and (b) playing another program in another channel in response to the activation of the channel advancement mechanism providing that the other program has attribute information which is related to attribute information of the initial program. In one implementation, the above-mentioned channel advancement mechanism includes an attribute-dependent channel actuation mechanism (such as channel left-right keys on a remote controller) for navigating through programs in respective channels based on attribute information associated with the programs. The attribute information associated with the programs can pertain to a category associated with the programs, or some other information associated with the programs.

The channels can include at least one broadcast channel containing a fixed schedule of programs that play at defined times. The channels can also include at least one on-demand channel containing on-demand programs that can play at times specified by the user.

A system and apparatus related to the above-described method are also described herein.

The use of channel left-right keys allows a user to sequence through related groups of channels that share related attribute information. This greatly simplifies the navigation through channels, especially for those users who are apt to make a large number of channel changes during a viewing session (that is, those users who are apt to “surf” through channels during a viewing session). The presentation of a group of related channels in a larger group of channels also provides an efficient technique for “targeting” the interests of a user, that is, by culling a specific body of information that is likely to interest the user based on the user's selection of an initial program in an initial channel.

Additional features and benefits of the above-described channel navigation technique will be described in the ensuing discussion.

### BRIEF DESCRIPTION OF THE DRAWINGS

FIG. 1 shows an exemplary system for implementing the channel left-right behavior described herein.

FIG. 2 shows a collection of channels, where each channel includes a group of programs.

FIG. 3 shows an exemplary remote controller module for use in the system shown in FIG. 1.

FIG. 4 shows an exemplary flowchart that describes channel left-right behavior.

FIG. 5 shows an example of channel left-right behavior.

FIG. 6 shows another example of channel left-right behavior.

FIG. 7 shows an alternative method for implementing the channel left-right behavior.

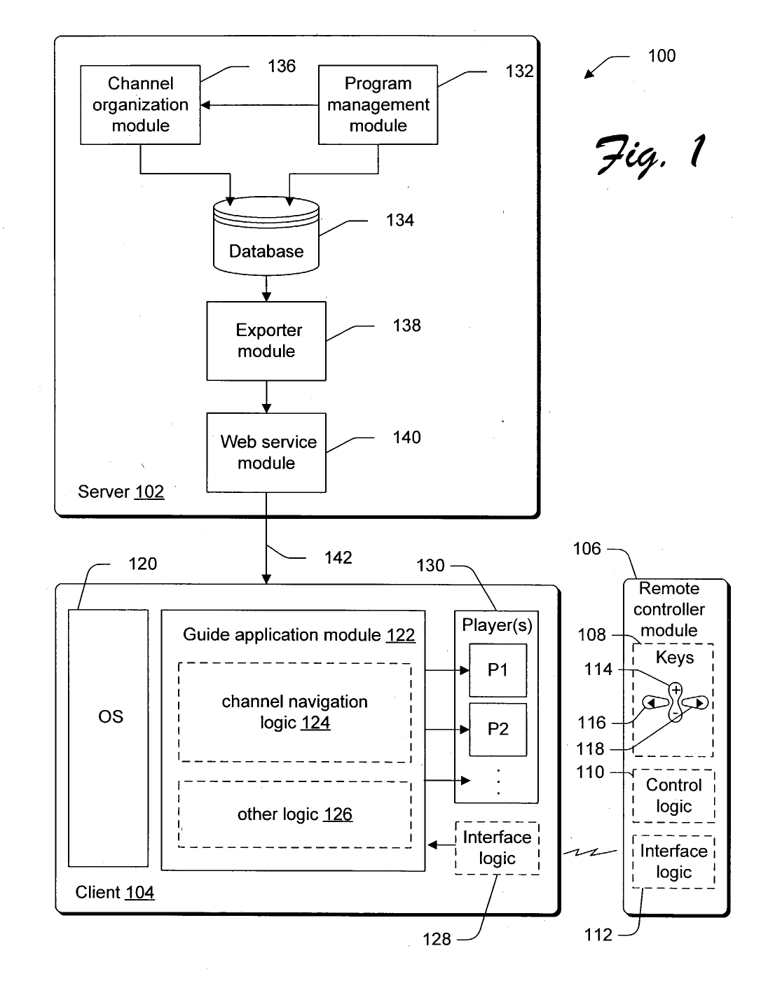

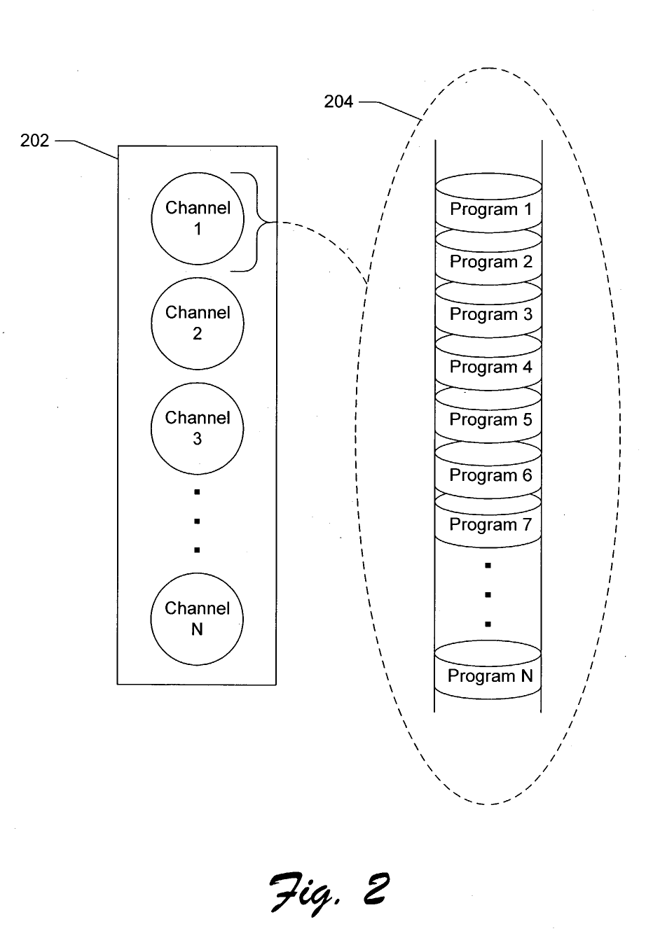

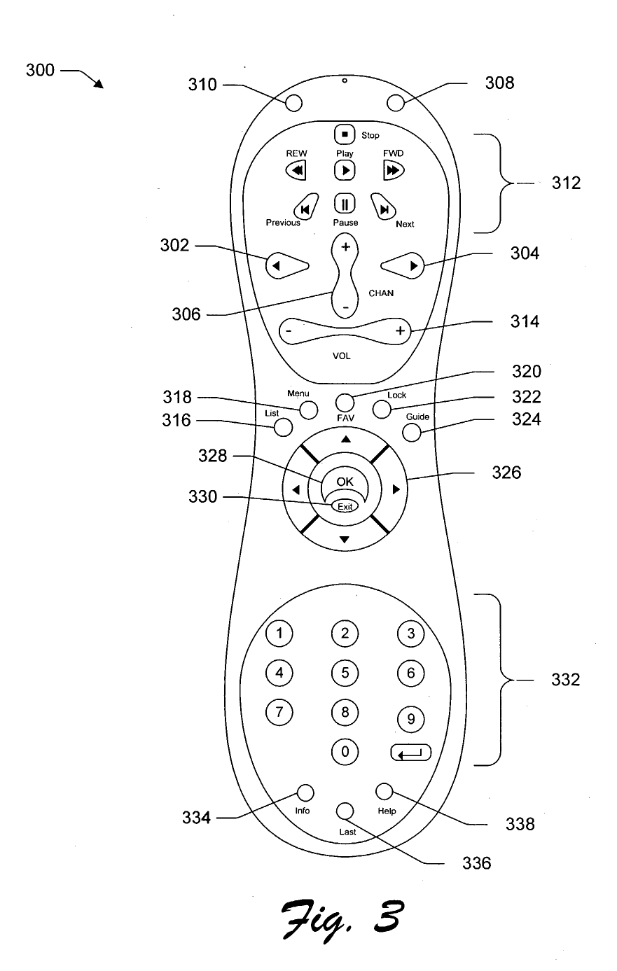

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

A. System-Level Implementation

The channel navigation behavior described herein can be implemented using many different kinds of system infrastructures. For instance, the behavior can be implemented in the context of a relatively conventional arrangement in which a head-end entity disseminates programs and/or related program data to users using conventional broadcasting strategies (such as satellite transmission, cable transfer, etc). Alternatively, the solution can be implemented in the context of an arrangement in which a head-end disseminates programs and/or related program data to users using a digital network, such as an Internet Protocol (IP) network. Alternatively, the solution can be implemented in the context of an arrangement where a local storage mechanism provides programs and/or related program data to users (e.g., where the storage mechanism can be under the control of the user, and located at the user's premises). Still other strategies can be used, including various kinds of hybrid arrangements that combine features of different kinds of strategies. For example, in one exemplary implementation, a user can receive program listing data, e.g., Electronic Program Guide (EPG) data, from an IP network source, yet receive the actual programs from conventional satellite or cable transmission paths. Generally, the channel navigation behavior can be used in any kind of infrastructure in which programs are presented to the user using the formalism of the channel motif.

In one implementation, the logic used to implement the channel navigation behavior is incorporated in equipment used at the viewing site. For instance, the implementing logic can be incorporated into a set-top box that is coupled to a user's viewing apparatus (e.g., television set). Alternatively, the implementing logic can be incorporated directly into the viewing apparatus itself. Still other strategies can be used for implementing the channel navigation behavior. (For instance, it is also possible to incorporate the implementing logic at the head-end, in whole or in part.)

FIG. 1 shows one exemplary and non-limiting IP network system 100 for implementing the channel navigation behavior described herein. The system 100 includes a server 102 coupled to a plurality of clients, including an exemplary client 104. For instance, client 104 can represent a set-top box coupled to a viewing apparatus (such as a television set), or can represent a viewing apparatus that incorporates logic for implementing the channel navigation behavior. A remote controller module 106 can be used to interact with the client 104 using a conventional communication technique, such as by infrared command signals. Although not shown, the client 104 can also receive programs and/or program data from conventional sources, such as conventional cable or satellite transmission sources.

An overview of the channel navigation behavior will be provided by first making reference to the remote controller module 106. The remote controller module 106 includes a collection of keys 108 for entering commands, control logic 110 for receiving the commands and generating instructions in response thereto, and interface logic 112 for forwarding the instructions to the client 104 via wireless command signals. The illustrated keys 108 include a conventional channel up-down key 114. This channel up-down key 114 includes a conventional rocking type of key that can be used to activate a first state by pressing a first end of the channel up-down key 114 (denoted by the symbol “+”), and used to activate a second state by pressing a second end of the channel up-down key 114 (denoted by the symbol “−”). The client 104 sequences through a list of channels in a “forward” direction (e.g., in increasing numerical order of channels) in response to activation of the “+” side of the channel up-down key 114, and sequences through the list of channels in a “reverse” direction (e.g., in decreasing numerical order of channels) in response to activation of the “−” side of the up-down key 114.

In addition, the keys 108 include a channel left key 116 and a channel right key 118, referred to collectively as channel left-right keys (116, 118). In response to the activation of the channel left key 116, the client 104 advances to another channel in the “reverse” direction (e.g., in decreasing numerical order of channels) providing that this other channel has a program with attribute information which is related to attribute information of an initial program in an initial channel (that is, the program that the user was initially playing). In response to the activation of the channel right key 118, the client 104 advances to another channel in the “forward” direction (e.g., in increasing numerical order of channels) providing that this other channel has a program with attribute information which is related to attribute information of the initial program in the initial channel. For example, assume that the user has selected an initial program in an initial channel for viewing. This initial program has attribute information associated therewith, such as a category attribute assigned thereto. In response to a user's activation of the channel left-right keys (116, 118), the client 104 sequences through channels containing programs that share the same category attribute. Assume, for example, that a user is watching a soccer game in an initial program presented on an initial channel. In response to the user's activation of the channel left-right keys (116, 118), the client 104 sequences through other channels that contain sports programs. In this manner, the user can be kept abreast of multiple soccer games that may be playing simultaneously. It can be seen that this channel navigation strategy is significantly more efficient and user-friendly than the conventional strategy described in the background section of this disclosure.

More generally, the channel left-right behavior can be performed to navigate within a group of channels that have programs with attribute information that is related in a defined manner. The term “attribute information” refers to any information associated with the programs, and can include one or more attributes associated with the programs (to be discussed in greater detail in Section B of this disclosure). For instance, in one implementation, the channel-left right behavior can be performed to visit a group of programs that share the same attribute. In another implementation, the channel-left right behavior can be performed to visit a group of programs that share multiple attributes in common. In another implementation, the channel left-right behavior can be performed to visit a group of programs that have attributes that are related in some defined manner, although not necessarily by simple equivalence. For instance, in this implementation, the channel left-right behavior can be performed to visit a group of programs that have attributes that fall within a defined class of attributes (such that, for instance, any program having an attribute of A, B, or C will be included). Other strategies can be used to define related programs, including various kinds of rule-based systems, fuzzy logic systems (to determine “similar” attributes), artificial intelligence systems, etc. In additional, the channel navigation behavior can also be partially or wholly determined based on marketing considerations. For instance, a system provider may want to tailor the sequence of programs associated with the channel left-right behavior to ensure that various commercials are presented to the user.

Further, the terms “up,” “down,” “left,” and “right,” are merely illustrative of one possible key arrangement. Different arrangements of keys are possible, such as by placing the left and right keys (116, 118) in a vertical orientation with respect to each other. Indeed, in another implementation, the left and right keys (116, 118) need not be associated with numerically decreasing and increasing channels, respectively. In this more general case, the channel left-right keys (116, 118) simply activate another channel within a group of channels, but these channels need not be presented in any kind of numerical order.

It can therefore be seen that a great number of permutations are possible on the channel-left right behavior motif. Nevertheless, to facilitate discussion, this disclosure proceeds primarily based on the exemplary and non-limiting scenario in which channel left-right behavior is performed for channels in a channel list having programs that share the same attribute in response to the activation of channel left-right keys (116, 118). In this specific case, the term “channel advancement” refers to navigating through channels in both a forward direction and a reverse direction (e.g., in numerically increasing order and numerically decreasing order, respectively). Further, in this exemplary case, an “adjacent channel” refers to a channel which is before or after an initial channel in a channel list. For instance, in a channel list including channels 1, 4, 8, 9, and 10, channel 4 can be said be “adjacent” to channels 1 and 8.

The client 104 includes functionality for implementing the behavior discussed above. Although not shown, the client 104 can include conventional computing hardware, such as one or more microprocessors (or other processing mechanisms), Random Access Memory (RAM), Read Only Memory (ROM), various disc storage mechanisms, interface mechanisms, one or more bus mechanisms for coupling different components together, and other conventional computing hardware.

The client 104 can incorporate logic and associated memory structures for implementing its various functions. Such logic can be implemented as instructions stored in the memory of the client 104. More specifically, the logic provided by client 104 can include an Operating System (OS) 120 for performing various general computing tasks associated with the operation of client 104. The client 104 can also include a guide application module 122 for performing various tasks associated with the presentation of programs and program data (e.g., EPG data) to a user, and for interacting with the user. For instance, the guide application module 122 can include channel navigation logic 124. Channel navigation logic 124 generally provides functionality used to sequence through channels based on input from remote controller module 106. The guide application module 122 also includes “other logic” 126. This other logic 126 generally represents other tasks performed by the guide application module 122, such as: receiving program data (e.g., EPG data) from the server 102; mapping the program data to the client's internal memory database (not shown); searching programs according to various specified attributes; presenting EPG data to a user; setting user-specified channel lists in response to input from the user, etc. Further, the logic incorporated in the client 104 can include interface logic 128 for interacting with the remote controller module 106 via a wireless communication path.

The client 104 plays programs for “consumption” by a user using one or more players 130. The players 130 may include any kind of analog or digital TV player, any kind of media player, any kind of wide-area network-enabled player, etc. In one implementation, the client 104 can combine different kinds of players together (such as players P1, P2, etc.). In this case, the client 104 includes logic for forwarding programs to respective players based on the players' ability to play the programs. For instance, a conventional TV broadcast program is presented to a conventional television (such as an analog or digital television set), while a wide-area network program is presented to an Internet-compatible player (such as a Hypertext Markup Language, i.e., HTML, player). In one implementation, the client 104 can be implemented as a unified console that incorporates all of the elements described above. In other implementations, the client 104 can be implemented as a set-top box that is communicatively coupled to the players 130. The different players can represent different software and/or hardware modules designed to process information for output to a single display screen. Alternatively, different players can provide information to different respective display screens. Still other implementation strategies can be used.

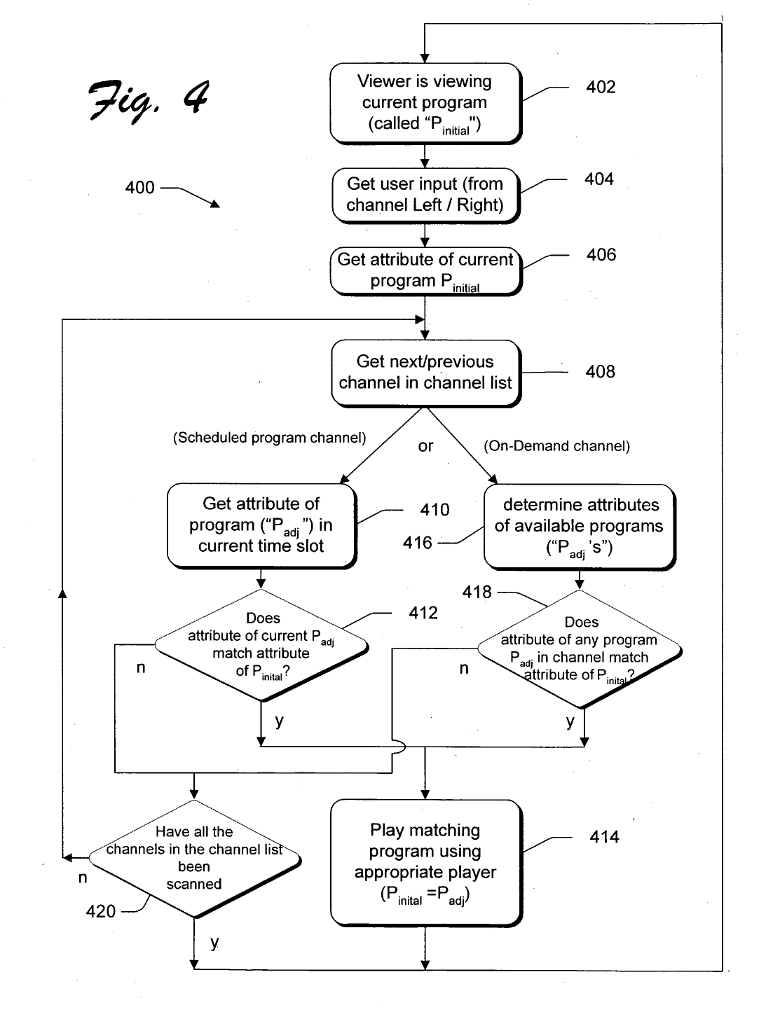

The channel navigation logic 124 implements the channel left-right behavior described above. More specifically, the channel navigation logic 124 is configured to play another program in another channel in response to the activation of the channel left-right keys (116, 118) providing that the other program has attribute information which is related to attribute information of the initial program. For instance, in one implementation, the channel navigation logic 124 includes attribute determination logic configured to determine attribute information associated with the initial program in the initial channel (e.g., by examining EPG data associated with the initial program). The channel navigation logic 124 further includes channel advancement logic configured to advance to a queried program in another channel in a channel list in response to the activation of the channel left-right keys (116, 118) in order to determine whether the queried program should be played. At this point, the attribute determination logic comes into play again to determine attribute information associated with the queried program in the other channel in the channel list (e.g., by again examining the EGP data). The channel navigation logic 124 further includes matching logic configured to determine whether the attribute information of the initial program generally matches the attribute information of the queried program. The client 104 is configured to play the queried program in the other channel if the attribute information of the initial program generally matches the attribute information of the queried program. If there is no match, the other program in the other channel is not played, prompting the channel navigation logic 124 to investigate the next channel in the channel list. If there are absolutely no matching programs, then the channel navigation logic 124 is configured to display the initial program in the initial channel, whereupon the user will assume that there are no matching channels (or, in an alternative implementation, a message can be displayed to alert the user to this fact). Additional details regarding the channel left-right behavior will be provided in the ensuing discussion of FIGS. 4-6.

The server 102 can include various modules for presenting programs and/or program data (e.g., EPG data) to the client 104. These modules can be implemented as one or more computing devices comprising known computing hardware (e.g., processor, RAM, ROM, disk storage, etc.) More generally, the server 102 can comprise equipment located at one head-end site, or can incorporate equipment distributed over multiple sites. Further, the server 102 can be administered by one commercial entity, or can represent different modules implemented by different commercial entities, such as different providers of programs and program data.

In the exemplary configuration shown in FIG. 1, the server 102 includes a program management module 132 for inputting programs and/or program data (e.g., EPG data) into a database 134. For instance, the program management module 132 can be configured to receive programs and/or program data in batch from a conventional broadcast source, cable source, wide-area network source (e.g., the Internet), or other source. For instance, a number of commercial entities provide EPG data. A channel organization module 136 receives the programs and/or program data provided by the program management module 132 and aggregates these programs and/or program data into one or more channels (if not already organized into channels). An exporter module 138 encodes the channel and program data into data files having a specified format for receipt by the client 104. A web service module 140 downloads the data files to the client 104 via communication path 142. The client 104 receives these data files from the server 102 and stores the data files in an EPG database (not shown) having various tables. This database supplies information that can be assembled to form a program guide for display to the user. Communication path 142 may represent a digital network communication path (such as an Internet communication path) formed from hardwired and/or wireless links, a conventional cable communication path, a satellite communication path, etc. In an alternative implementation, various programs can be provided to the client 104 from a local program repository, such as a hard disk library, a DVD library, etc. Still other strategies can be used to provide program information to the server 104.

In one implementation, the client 104 receives only program data (e.g., EPG data) from the server 102, and then later receives the actual programs when the user tunes to the programs. More specifically, the client 104 can receive the actual program from any source, such as server 102, another source coupled to the digital network, a cable source, a satellite source, etc. Many permutations of program delivery options are possible.

B. Channel Formation and Contents

FIG. 2 shows a collection of channels 202 (e.g., channels 1-N). Each channel includes a plurality of programs associated therewith. For instance, channel 1 in the collection of channels 202 includes a plurality of programs 204 associated therewith (e.g., programs 1-N).

The concepts of a “channel” and a “program” have broad connotations as used in this disclosure. For instance, a channel can include a broadcast channel, which generally refers to a channel containing programs that are presented at scheduled times. A broadcast channel can specifically include: a) an analog TV channel received via cable or other source; b) a digital TV channel received via cable or other source; c) an Internet Protocol (IP) video channel formed from a compilation of streaming video programs received via an IP broadband network or other source; d) an IP audio channel formed from a compilation of streaming audio programs, etc. The broadcast category of programs can include information that is presented in live fashion such that its presentation schedule is determined and fixed by the live event itself. The broadcast category of programs can also include information that is pre-recorded and organized at a head-end into a fixed schedule (and hence, such programs can be referred to as “time-shifted” programs).

The channels can also include an on-demand channel, which generally refers to a channel containing programs that are provided at any time specified by a user. An on-demand channel can include: a) a video on-demand channel that contains a compilation of streaming video programs via an IP broadband network or other source; b) an audio on-demand channel that contains a compilation of streaming audio programs via an IP broadband network or other source; c) a web-enabled markup language channel (such as an HTML channel) that contains a complication of web markup pages via an IP broadband network or other source; d) an image on-demand channel that contains various image programs via an IP broadband network or other source (such as well know .BMP, .JPG, GIF programs, etc.); e) a Flash on-demand channel that provides various Flash memory programs via an IP broadband network or other source; f) an application on-demand channel that provides various applications (such as games) via an IP broadband network or other source, etc.

In addition, one or more channels can combine content associated with multiple different channels described above (e.g., different broadcast and on-demand channels), thus providing a “mixed content” channel. Further, a subset of the above-mentioned channels can be implemented as “free channels,” meaning that the provider does not charge a fee for the viewing of programs provided by the channels. Another subset of the above-mentioned channels can be implemented as “subscribed channels,” meaning that the provider does require that the user pay a fee to watch the programs provided by the channels. In this latter category, in one implementation, if a user purchases a channel, then all programs in this channel can be viewed.

In still another implementation, the user can specify criteria which determine the formation of a channel. For instance, a user can input various attributes regarding the programs via the client 104. The client 104 can include logic for then organizing programs received from the server 102 (or elsewhere) into channels based on the criteria. For instance, a user may instruct the client 104 to cull a channel that contains a certain category of programs, a certain source of programs (e.g., a broadcast or on-demand sources), a certain price class of programs, a certain type of programs (games, audio, etc.), etc. The client can then respond by examining the program data (e.g., EPG data) received from the server 102 to determine whether the programs match the input criteria, and then by aggregating any matching programs into a channel by appropriately organizing the EPG data retrieved from the EPG database. Thus, in this implementation, the client 104, and not the server 102, defines the channels.

Generally, traditional television broadcasting strategies assign channels to discrete broadcasting frequencies for dissemination to users. The programs described above generally organize channels in a manner which resembles these traditional channels. But in the above-described implementation, the channels are not always associated with different broadcast frequencies, and thus can be regarded, in some cases, as virtual channels. The organization of a wide variety of programs into channels may make it more likely that a user will “consume” such programs. This is because the user is already familiar with the channel motif due to its traditional use in traditional television broadcasting strategies. That is, due to this familiarity, the user may be more willing and able to explore and consume such programs.

However formed, the channel information captured by the server 102 (or define by the client 104) may include the following non-exclusive list of fields: a) channel number; b) channel localization information for the channel (which, for a broadcast TV signal, represents the frequencies of the channel, and for a broadcast IP channel, includes the URI of the channel resource); c) channel type (e.g., broadcast channel or on-demand channel); d) channel price; e) channel name, etc.

The program information captured by the server 102 can include the following non-exclusive list of fields: a) program title; b) program episode title; c) program price; d) program category (e.g., sports content, news content, children's content, etc.); e) program sub-category; f) program duration; g) program localization (in the case of an on-demand channel); h) program type (which identifies the type of player that should be used by the client 104 to play the program); i) actor information; j) quality rating (e.g., using a star ranking system); k) age-related classification (e.g., G, PG13, R, etc.), etc. In the context of this disclosure, all of the program information described above constitutes attributes of the program. In one implementation, this attribute information comprises ancillary coded digital program data that is forwarded by the server 102 to the client 104 for storage in the EPG database. The channel left-right keys (116, 118) can be used to sequence through channels that share one or more of the above-described attributes. The above-described channel navigation logic 124 provided by the client 104 performs this task by reading the ancillary coded information in the EPG database.

C. Remote Controller Module

FIG. 3 shows an exemplary remote controller module 300 for interacting with the client 104. Of particular note here is the channel left key 302, the channel right key 304, and the channel up-down key 306 which perform the same functions as the same-named keys described in the context of FIG. 1. For instance, the channel left-right keys (302, 304) are used to sequence through a series of channels that share the same attribute as an initially selected program. More specifically, as described above, each program may include plural kinds of attributes. In one implementation, in response to the activation of the channel left-right keys (302, 304), the client 104 can be automatically programmed to execute channel left-right behavior based on a predefined attribute, such as program category. Hence, in this example, the category attribute is automatically associated with the channel left-right keys (302, 304). In another implementation, the client 104 can be configured to permit the user to select the kind of attribute that is associated with the channel left-right keys (302, 304). This selection can be performed by allowing the user to select one attribute among a plurality of attributes via an on-screen display of program attributes presented to the user by the client 104, or by some other input mechanism.

The remote controller module 300 also includes a number of additional keys for performing other functions. As these keys are not the primary focus of this disclosure, their functions will only be summarily described. To begin with, a power key 308 is used to instruct the client 104 to power up (e.g., by powering on a set-top box provided by the client 104). A mute key 310 is used to turn off the audio presentation provided by the client 104. A series of program play control keys 312 (stop, rewind, play, forward, previous, pause, and next) are used to control the presentation of a program in a conventional manner (providing that the presentation of the program can be controlled in this manner). For instance, the previous and next keys in this set of keys 312 can be used to skip to the next and previous programs, respectively, in a video on-demand channel, etc. A volume key 314 changes the volume of a program currently being presented. A list key 316 displays a program play list. A menu key 318 displays an application menu. A favorite (FAV) key 320 launches a favorites panel that provides a list of favorite programs. A lock key 322 launches a parental blocking setup screen for a current or selected show. A guide key 324 launches a program guide. The left, right, up, and down keys 326 allow a user to navigate through various buttons, lists, etc. as displayed by the client 104. An OK key 328 disposed in the center of keys 326 allows a user to select a highlighted item displayed by the client 104. An exit key 330 dismisses an active page or panel displayed by the client 104. Numeric keys 332 permit a user enter numeric information. Within this set of keys 332, an enter key is used to forward numeric information entered by the numeric keys to the client 104. An information key 334 prompts the client 104 to present program information. A last key 336 tunes the client 104 to a previously selected channel. Finally, a help key 338 prompts the client 104 to provide help information to a user. The organization of keys in the remote controller module 300 is entirely exemplary. For example, additional keys can be added. Alternatively, a subset of the keys shown in FIG. 3 can be omitted. Alternatively, the positional arrangement of keys shown in FIG. 3 can be varied.

Further, the channel left-right keys (302, 304) can be modified in various ways. In one alternative implementation, plural sets of channel left-right keys can be used, with each set assigned to a different program attribute. For instance, a first set of channel left-right keys can be allocated for sequencing through channels based on the attribute of program category. A second set of channel left-right keys can be allocated for sequencing through channels based on the attribute of program actor, and so on. For instance, assume that a user is watching a news program that features a certain anchorperson. Pressing a category-related set of channel left-right keys will prompt the client 104 to sequence through a series of channels that all pertain to the category of news programs. Pressing an actor-related set of channel left-right keys will prompt the client 104 to sequence through a series of channels that all feature the identified anchorperson. This mapping of attribute information to sets of channel left-right keys can be fixed by the client 104 in advance, or can be specified by the user in the manner described above (e.g., by an on-screen display presented to the user by the client 104, or by some other mechanism).

In yet another implementation, the remote controller module 300 can include a separate attribute selection key (or keys). This attribute selection key (or keys) defines the program attribute that is used by the client 104 in performing the channel left-right behavior. For instance, instead of including plural different sets of channel left-right keys assigned respectively to different attributes, the remote controller module 300 can include a single set of channel left-right keys and one or more attribute selection keys which defines the attribute associated with the single set of channel left-right keys. In one example, the attribute selection key can comprise a switch having multiple positions, with each position associated with a different attribute (e.g., category, actor, rating, etc.). Still other key strategies for sequencing through programs that share the same attribute can be used.

Finally, the channel left-right keys (302, 304) can be implemented on other modules than the remote controller module 106. For instance, the client 104 itself can include an input key mechanism on its console housing which includes channel left-right keys. Alternatively, the channel left-right keys (302, 304) can be implemented as graphical touch-screen buttons provided by a graphical user interface, or like input mechanism.

D. Channel Left-Right Behavior

FIG. 4 shows an operation flow 400 for executing the channel left-right behavior. The flow 400 begins in step 402 in which a user has “tuned” to a desired initial program provided in an initial channel. This program is referred to in FIG. 4 as “Pᵢₙᵢₜᵢₐₗ.” Then presume that the user has activated the channel left-right keys (e.g., channel left-right keys 116, 118 shown in FIG. 1). In step 404, the client 104 receives the user's left-right instruction. In step 406, the client determines the attribute of the initial program Pᵢₙᵢₜᵢₐₗ (e.g., by examining the EPG database). Assume, for instance, that the client 104 is configured to examine the category of the program. In this case, in step 406, the client will determine the category of the initial program Pᵢₙᵢₜ. In step 408, the client 104 also advances to the next or previous channel in the channel list, referred to in FIG. 4 as “P_{adj}” (where P_{adj} refers to a program which is adjacent to the initial program Pᵢₙᵢₜᵢₐₗ in a list of channels containing programs).

More specifically, the adjacent channel can be a broadcast channel or an on-demand channel. As mentioned above, a broadcast channel presents programs at specified scheduled times. An on-demand channel presents programs at any time requested by a user. Thus, FIG. 4 executes different operations depending on whether the adjacent channel is a broadcast channel or an on-demand channel. If the adjacent channel is a broadcast channel, the client 104 determines the attribute of the program that is currently playing on the broadcast channel (in step 410). In step 412, the client 104 then compares the attribute of the initial program Pᵢₙᵢₜᵢₐₗ with the attribute of the program P_{adj} in the adjacent channel (e.g., as retrieved from the EPG database). If these attributes match (meaning, for example, that the programs share the same category), the client 104 plays the program in the adjacent channel (in step 414). In one implementation, “play” means actually presenting the program to the user to watch. For instance, in this context, “play” can constitute tuning to a broadcast channel, requesting initiation of playback of media from a server, initiating playback of media stored at the client, or some other technique for presenting a program. In another implementation, “play” can constitute presenting only EPG data relating to the program, which gives the user the option to formally play (watch) it.

On the other hand, if the adjacent channel is an on-demand channel, the client 104 scans through the list of on-demand programs in the channel and identifies the respective attributes of the programs (in step 416). In step 418, the client 104 determines whether any program in the channel of on-demand programs has an attribute which matches the attribute of the initial program. If so, in step 414, the client 104 plays the matching program. If the adjacent on-demand channel includes plural programs that share the same attribute as the initial program, the client 104 can be configured to handle this issue in different ways, such as by presenting the first matching program in the channel, or by presenting a list of matching programs to a user, etc. As step 414 indicates, upon playing the program in the adjacent channel, this program now assumes the role of the initial program (Pᵢₙᵢₜ=P_{adj}), such that, if the user again presses the channel left-right keys, then the steps shown in FIG. 4 will be repeated to find the next available channel having the same attribute.

However, in the event that the adjacent channel (whether it is a broadcast channel or an on-demand channel) does not have a program which matches the attributes of the initial program, then the flow in FIG. 4 advances back to step 408, where another channel in the sequence of channels is investigated to determine whether it contains a matching program. This loop is repeated by sequencing through channels in the channel list until a matching program is found on one of the channels in channel list.

There is a possibility that no program in another channel matches the attributes of the initially presented program. This event is detected by the decision block of step 420. That is, step 420 determines whether a complete loop has been made through the channels in the channel list, starting with the channel that contains the initial program. If this is the case, the client 104 leaves the initially displayed program undisturbed (and/or displays a message indicating that there is no matching program).

The procedure shown in FIG. 4 can be modified in different ways. For instance, the client can be configured such that the channel left-right behavior is executed in a loop of programs on different channels providing that the channels share multiple attributes in common (that is, not simply one attribute in common). For instance, the client 104 can be configured to present looping behavior for programs on different channels providing that the programs involve a certain actor, e.g., Robin Williams, coupled with a certain movie genre, such as comedy. The resultant looping behavior will exclude movies in which Robin Williams appears that are not comedies. Still other modifications can be made to the basic strategy shown in FIG. 4.

Also, as explained above, channel left-right behavior can be performed for cases in which matching attribute information is determined in more complex ways than simple equivalency. In one implementation, channel left-right behavior can be implemented for programs with attribute information that falls into a general class, or has some other defined tying relationship. It is also possible to incorporate purely commercial considerations into the channel left-right behavior. For instance, in one case, a provider can design the channel navigation logic 124 such that it inserts one or more advertising-related programs into the loop of channels activated by the channel left-right keys (116, 118). Many other permutations are possible.

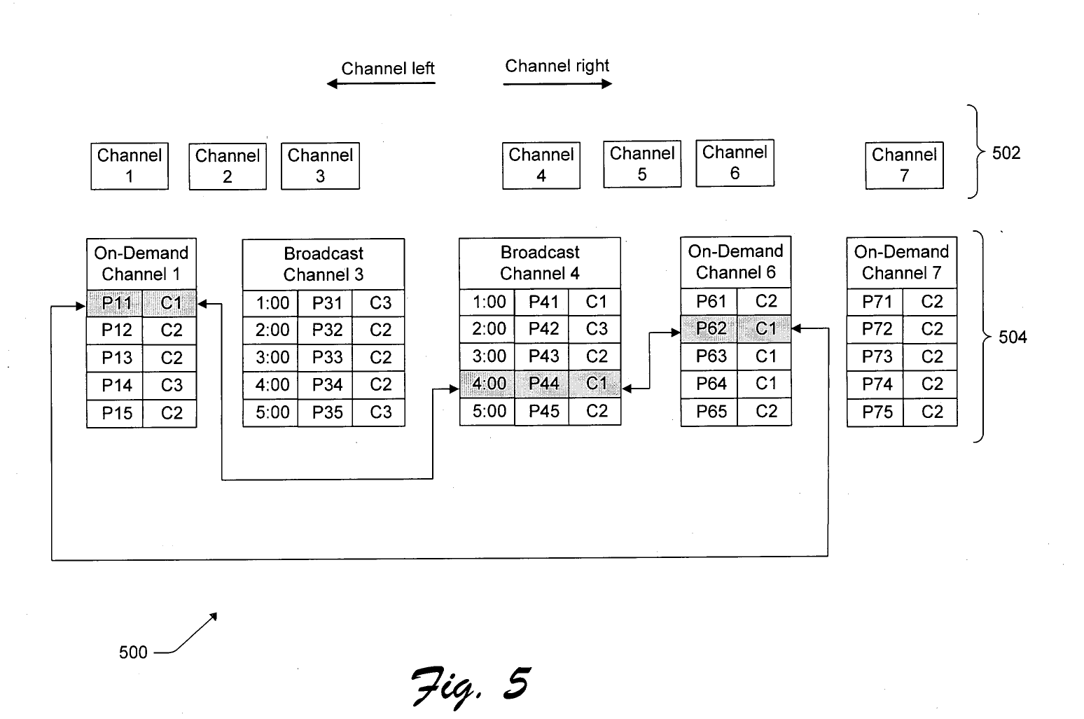

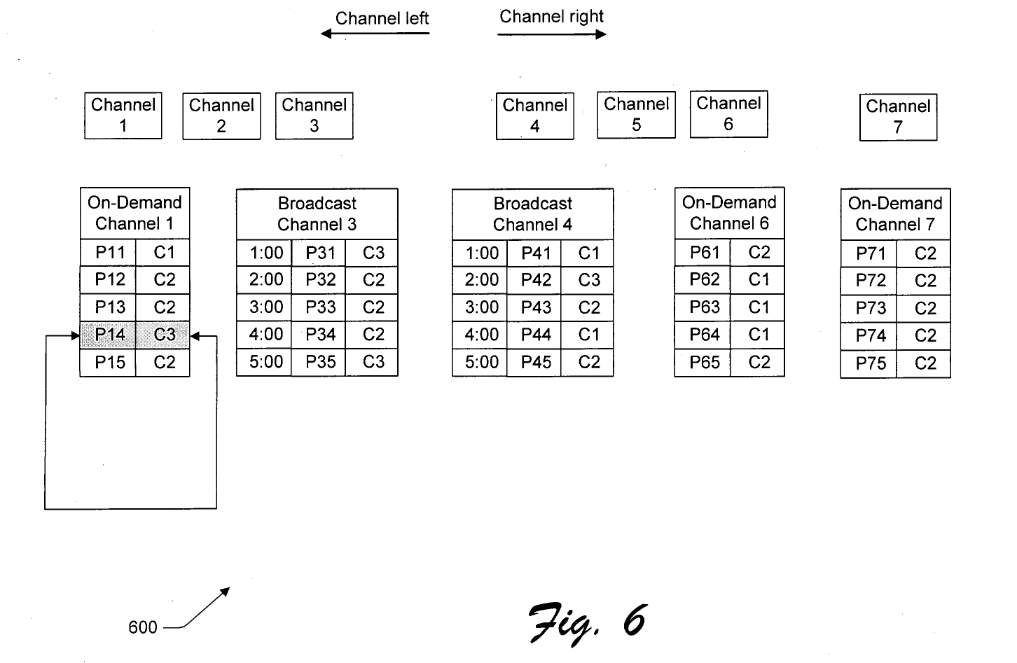

FIGS. 5 and 6 supplement FIG. 4 by showing different exemplary scenarios for advancing through a channel list. More specifically, in scenario 500 shown in FIG. 5, field 502 in FIG. 2 represents an entire universe of available channels provided to the client 104 by the server 102. In this exemplary case, there are 7 channels that are available (but typically, many more channels will be provided, such as several hundred channels). However, the user may have subsequently culled a smaller number of channels from this list to provide a user-defined channel list. Field 504 shows the user-defined channel list. In this exemplary case, the user has omitted channels 2 and 5 from the entire universe of channels to create the user-defined channel list in field 504. This channel list can be implemented in different ways. In one implementation, the client 104 can store a lxN array to record the channel list (where N is total number of available channels). The client 104 can store a 1-value in the array if the channel is included in the channel list and a 0-value in the array if the channel is not included in the channel list.

In one implementation, the channel left-right behavior is implemented by sequencing through a list of channels in the user's channel list. It will be apparent, however, that the channel left-right behavior can be implemented on any channel list, including the original channel list including channels 1-7.

In the scenario 500 shown in FIG. 5, assume that the initial program being viewed by the user is program P11 provided by on-demand channel 1. This program has an attribute of category C1 (as assessed from the program data stored in the client 104). Further assume that the user presses the channel right key 118 at 4:00 pm while watching program P11. This prompts the client 104 to investigate broadcast channel 3 (the next available channel in the channel list) to determine whether it contains a program playing at 4:00 pm that matches the attribute of P11. Channel 3 includes program P34 playing at 4:00 having a category of C2 assigned thereto. Category C2 does not match the attribute of program P11 (category C1), and hence the client 104 does not play program P34. The client 104 thus proceeds to examine the next available channel in the user's channel list, e.g., broadcast channel 4. In this case, program P44 that is presented at 4:00 pm does include an attribute that matches the attribute of the program P11 (that is, an attribute of category C1). Thus, client 104 plays the program P44.

Assume that the user again presses the channel right key 118, or has maintained the channel right key 118 continually depressed from its initial activation. In this case, the client 104 will investigate the next channel in the user's channel list, e.g., on-demand channel 6. Because this is an on-demand channel, the timing of the programs contained therein is not critical. Thus, the client 104 proceeds to determine whether any of the programs contained in this channel include an attribute which matches the attribute of the initial program (category C1). Program P62 has a matching attribute and is thus played. While channel 6 has multiple programs having category C1, in this implementation, the client 104 is configured to play the first-identified matching program.

If the user presses the channel right key 118 yet again, the client 104 will investigate the next channel, e.g., on-demand channel 7. In this case, channel 7 does not contain any programs in C1 category. This prompts the client 104 to sequence back to the channel from which it started, namely channel 1, by presenting program P11. The same type of behavior described above is also performed by pressing the channel left key 116, which prompts the client 104 to cycle though the loop shown in FIG. 4 in a counterclockwise direction.

FIG. 6 presents a scenario 600 in which there are no programs on any channels in the user's channel list that match the attribute of the initially presented program. For instance, assume that the user is viewing program P14 in on-demand channel 1, which is assigned to category C3. At 4:00 pm the user activates the channel left or the channel right keys (116, 118). However, the broadcast channels do not include any programs presented at 4:00 pm having the C3 category assigned thereto. Further, the on-demand channels do not include any channels in the C3 category. The client 104 will scan the list of channels, determine that there are no matching programs, and thus leave the presentation of the initial program P14 undisturbed.

E. Alternative Implementation of Channel Left-Right Behavior

The above-described functionality presupposes that the client 104 investigates the attributes of the programs at the time that the user activates the channel left-right keys (116, 118). In an alternative implementation, the client 104 can be configured to automatically cull a specific grouping of channels in advance that share a common attribute or attributes. This grouping of channels defines a channel list that dynamically changes based on changes in program content at different times. For instance, suppose that a channel list is automatically created for channels containing news-related programming. This channel list will include a great number of channels during periods in which such news programs are typically aired (such as at 6:00 pm), but will include a reduced set of programs at other times. If an on-demand channel includes a news program, then this channel will be a stable member in the channel list. Once a channel list is formed in this manner, pressing the channel left-right keys (116, 118) results in sequencing through channels in the channel list in reverse or forward directions. There is no need to investigate the category of such channels at the time of activation of the left or right keys (116, 118) because the channel list implicitly includes only members that match the desired attribute.

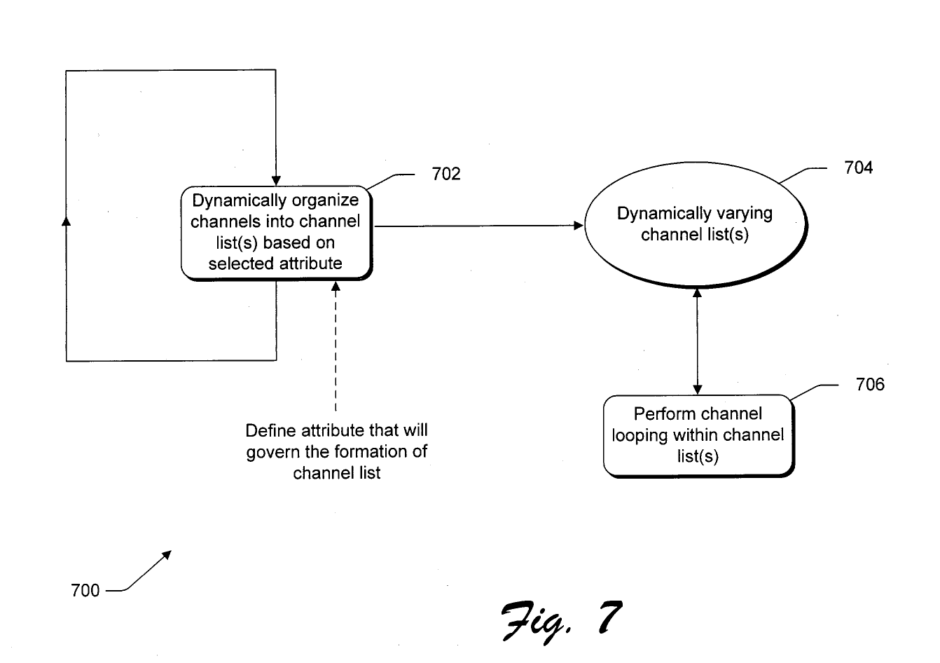

FIG. 7 illustrates a procedure 700 which describes the above-described concept in more formal terms. In step 702, the client 104 repeatedly and dynamically investigates the program data (e.g., EPG data) provided by a plurality of channels. Based on this investigation, the client 104 culls one or more channel lists 704 from the channels. Each channel list includes channels that have a similar attribute or attributes. For instance, one channel list may represent channels that currently feature children's programming. Step 706 indicates that the channel left-right behavior is executed by looping through channels in one of the channel lists 704. The channel looping behavior will change over time due to the dynamically varying group of members in the channel list.

In the above-described procedure, the channel left-right keys (116, 118) can be allocated to a specific channel list. Similar to the discussion of FIG. 3, different key mechanisms can be used to vary this basic concept. For instance, a user can program the client 104 to specify which kind of channel list will be associated with the channel left-right keys (116, 118). Alternatively, the remote controller module 106 can include plural different sets of channel left-right keys (116, 118) corresponding to different channel lists. Alternatively, the remote controller can include a separate channel list key (or keys) which specifies the channel list that is assigned to the left-right channel keys (116, 118). Still alternatively, the remote controller module 106 can eliminate the up-down channel advancement keys; in this case, the remote controller module 106 can use the channel left-right keys (116, 118) to perform all the channel sequencing tasks (e.g., by allowing the user to specify whether the channel left-right keys 116, 118 are associated with the entire set of available channels, or a more restricted attribute-specific channel list).

Still additional strategies can be used to vary the above-described channel looping behavior within channel lists. For instance, it is possible to execute channel left-right behavior within lists that are static—that is, within lists that do not dynamically change. For instance, it is possible to perform channel left-right behavior in a list devoted to channels that originate from a certain source (e.g., broadcast or on-demand), a list devoted to channels that have a certain type of program (e.g., game applications), etc.

F. Conclusion

A solution for advancing through channels based on a shared program attribute was described. The solution results in a less cumbersome technique for navigating among channels compared to conventional channel navigation strategies.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for advancing through channels containing programs, comprising:
receiving an indication that a user has activated a channel advancement mechanism while playing an initial program in an initial channel; and
playing another program in another channel in response to the activation of the channel advancement mechanism providing that the other program has attribute information which is related to attribute information of the initial program.

2. A method according to claim 1, wherein the channel advancement mechanism includes an attribute-dependent channel actuation mechanism for advancing through programs in the list of channels based on attribute information associated with the programs.

3. A method according to claim 2, wherein the channel advancement mechanism further includes an attribute-independent channel actuation mechanism for navigating through programs in a list of channels regardless of attribute information associated with the programs.

4. A method according to claim 1, wherein the other program is determined to have attribute information which is related to the attribute information of the initial program when an attribute associated with the other program generally matches an attribute associated with the initial program.

5. A method according to claim 4, wherein the attribute includes at least one of:
category of a program;
actor-related information associated with a program; and
ranking of a program.

6. A method according to claim 1, wherein the channels include at least one channel containing broadcast programs, wherein the broadcast programs are presented at scheduled times.

7. A method according to claim 1, wherein the channels include at least one channel containing on-demand programs, wherein each of the on-demand programs can be played at a time specified by a user.

8. A method according to claim 1, wherein the channels include at least one channel that is formed in response to a user's specified query, wherein the query defines at least one criterion for forming the at least one channel.

9. A method according to claim 1, wherein the playing includes playing the other program in the other channel using a player appropriate to the other program.

10. A method according to claim 1, wherein the playing further comprises:
determining attribute information associated with the initial program in the initial channel;
advancing to a queried program in another channel in a channel list in response to the activation of the channel advancement mechanism in order to determine whether the queried program should be played;
determining attribute information associated with the queried program in the othert channel in the channel list;
determining whether the attribute information of the initial program generally matches the attribute information of the queried program; and
playing the queried program in the other channel in the channel list if the attribute information of the initial program generally matches the attribute information of the queried program.

11. A method according to claim 10, wherein the other channel in the channel list contains programs to be played at scheduled times, and wherein the determining of whether the attribute information of the initial program matches the attribute information of the other program includes determining whether a program currently being presented by the other channel in the channel list has attribute information which matches the attribute information of the initial program.

12. A method according to claim 10, wherein the other channel in the channel list contains on-demand programs, and the determining of whether the attribute information of the initial program matches the attribute information of the other program includes determining whether there is an on-demand program in the other channel in the channel list that has attribute information which matches the attribute information of the initial program.

13. A method according to claim 10, wherein the channel list is defined by the user.

14. A method according to claim 1, where the playing comprises:
playing the other program in a channel list in response to the activation of the channel advancement mechanism, wherein the channel list has been assembled prior to the activation of the channel advancement mechanism based on attribute information associated with programs in the channels.

15. A method according to claim 14, wherein channel membership in the channel list varies based on time.

16. A computer-readable medium having computer-executable instructions for performing the method recited in claim 1.

17. An apparatus for advancing through channels containing programs, comprising:
interface logic configured to receive an indication that a user has activated a channel advancement mechanism while playing an initial program in an initial channel; and
channel navigation logic configured to play another program in another channel in response to the activation of the channel advancement mechanism providing that the other program has attribute information which is related to attribute information of the initial program.

18. An apparatus according to claim 17, wherein the channel navigation logic is configured to determine whether the other program has attribute information which is related to the attribute information of the initial program when an attribute associated with the other program generally matches an attribute associated with the initial program.

19. An apparatus according to claim 18, wherein the attribute includes at least one of:
category of a program;
actor-related information associated with a program; and
ranking of a program.

20. An apparatus according to claim 17, wherein the channels include at least one channel containing broadcast programs, wherein the broadcast programs are presented at scheduled times.

21. An apparatus according to claim 17, wherein the channels include at least one channel containing on-demand programs, wherein each of the on-demand programs can be played at a time specified by a user.

22. An apparatus according to claim 17, wherein the apparatus includes channel formation logic configured to form at least one channel in response to a user's specified query, wherein the query defines at least one criterion for forming the at least one channel.

23. An apparatus according to claim 17, further including a plurality of players, wherein the apparatus is configured to play the other program in the other channel using a player appropriate to the other program.

24. An apparatus according to claim 17, wherein the channel navigation logic further includes:
attribute determination logic configured to determine attribute information associated with the initial program in the initial channel;
channel advancement logic configured to advance to a queried program in another channel in a channel list in response to the activation of the channel advancement mechanism in order to determine whether the queried program should be played, wherein the attribute determination logic is further configured to determine attribute information associated with the queried program in the other channel in the channel list; and
matching logic configured to determine whether the attribute information of the initial program generally matches the attribute information of the queried program, wherein the apparatus is configured to play the queried program in the other channel in the channel list if the attribute information of the initial program generally matches the attribute information of the queried program.

25. An apparatus according to claim 24, wherein the other channel in the channel list contains programs to be played at scheduled times, and wherein the matching logic is configured to determine whether a program currently being presented by the other channel in the channel list has attribute information which matches the attribute information of the initial program.

26. An apparatus according to claim 24, wherein the other channel in the channel list contains on-demand programs, and the matching logic is configured to determine whether there is an on-demand program in the other channel in the channel list that has attribute information which matches the attribute information of the initial program.

27. An apparatus according to claim 24, wherein the channel list is defined by the user.

28. An apparatus according to claim 17, where the channel navigation logic is configured to play another program in a channel list in response to the activation of the channel advancement mechanism, wherein the channel list has been assembled prior to the activation of the channel advancement mechanism based on attribute information associated with programs in the channels.

29. An apparatus according to claim 28, wherein channel membership in the channel list varies based on time.

30. A computer-readable medium having computer-executable instructions for implementing the logic recited in claim 1.

31. A system for advancing through channels containing programs, comprising:
a client including:
interface logic configured to receive an indication that a user has activated a channel advancement mechanism while playing an initial program in an initial channel; and
channel navigation logic configured to play another program in another channel in response to the activation of the channel advancement mechanism providing that the other program has attribute information which is related to attribute information of the initial program; and
a server, communicatively coupled to the client, configured to provide attribute information regarding programs to the client.

32. An apparatus according to claim 31, wherein the channel navigation logic is configured to determine whether the other program has attribute information which is related to the attribute information of the initial program when an attribute associated with the other program generally matches an attribute associated with the initial program.

33. An apparatus according to claim 32, wherein the attribute includes at least one of:
category of a program;
actor-related information associated with a program; and
ranking of a program.

34. A system according to claim 31, further comprising a remote controller module communicatively coupled to the client, wherein the remote controller module provides the channel advancement mechanism.

35. An apparatus for interacting with a system for advancing through channels containing programs, comprising:
control logic for controlling the operation of the apparatus;
a channel advancement mechanism coupled to the control logic, wherein the channel advancement mechanism includes an attribute-dependent channel advancement mechanism for navigating through programs in respective channels providing that the programs share related attribute information, and for generating control instructions in response thereto; and
a communication interface for sending the control instructions to the system for use by the system in executing the control instructions.

36. An apparatus according to claim 35, wherein the channel advancement mechanism further includes an attribute-independent channel actuation mechanism for navigating through programs in respective channels regardless of whether the programs share the same attribute and for generating control instructions in response thereto.

37. A method for advancing through channels containing programs, comprising:
defining attribute information;
forming a channel list containing channels with programs having features which generally match the attribute information;
receiving an indication that a user has activated a channel advancement mechanism; and
advancing to a program provided by a channel in the channel list in response to the activation of the channel advancement mechanism.

38. A method according to claim 37, wherein the step of forming a channel list is repeated to dynamically modify the channel list.

39. An apparatus for advancing through channels containing programs, comprising:
channel list formation logic configured to form a channel list containing channels with programs having features which generally match defined attribute information;
channel list storage logic configured to store the channel list;
interface logic configured to receive an indication that a user has activated a channel advancement mechanism; and
channel advancement logic configured to advance to another program in the channel list upon an indication that the user has activated the channel advancement mechanism.

40. An apparatus according to claim 39, wherein the channel list formation logic is configured to repeatedly modify the channel list.

41. A method for forming a channel including multiple programs, comprising:
receiving an input from a user which specifies attribute information;
forming a channel including programs having attribute information which generally matches the attribute information specified by the user;
receiving another input from a user which activates the channel; and
in response to the other input, playing a program within the channel.

42. A method according to claim 41, wherein the forming is performed in a client, wherein the client is communicatively coupled to a server.

43. An apparatus for forming a channel including multiple programs, comprising:
interface logic configured to receive an input from a user which specifies attribute information;
channel formation logic configured to form a channel including programs having attribute information which generally matches the attribute information specified by the user; and
program playing logic configured to play a program within the channel in response to a user activating the channel.

44. An apparatus according to claim 43, wherein the channel formation logic is implemented in a client, wherein the client is communicatively coupled to a server.
